(19) United States
(12) Patent Application Publication
(10) Pub. No.: US 2018/0088970 A1
(43) Pub. Date: Mar. 29, 2018

(54) MAPPING OF USER INTERFACES WITHIN APPLICATIONS

(71) Applicant: T-Mobile USA, Inc., Bellevue, WA (US)

(72) Inventors: Michael J. Mitchell, Bellevue, WA (US); Peter P. Myron, Renton, WA (US); Samson Kim-Sun Kwong, Bellevue, WA (US)

(21) Appl. No.: 15/280,100

(22) Filed: Sep. 29, 2016

(51) Int. Cl. G06F 9/44; G06F 3/0481; G06F 17/22; G06T 11/20; G06K 9/18

(52) U.S. Cl. CPC G06F 9/4446; G06F 3/0481; G06K 9/18; G06T 11/206; G06F 17/2247

(57) ABSTRACT

A mapping application determines locations of user interfaces (UIs) within content. Upon determining locations of UIs within the content, the mapping application evaluates the UIs to determine where within the content the UI will lead a user when the UI is activated. For example, the mapping application determines a first location where a first UI will take the user within the content when the first UI is activated. At this first location, the mapping application determines a second location where a second UI located at the first location will take the user when the second UI is activated. Based upon determining where the UIs will take a user within the content when the UIs are activated, the mapping application generates a flow diagram of the content that maps one or more UI paths within the content.

### BACKGROUND

In recent years, telecommunication devices have advanced from offering simple voice calling services within wireless communication networks to providing users with many new features. Telecommunication devices now provide messaging services such as email, text messaging, and instant messaging; data services such as Internet browsing; media services such as storing and playing a library of favorite songs; location services; and many others. Thus, telecommunication devices, referred to herein as mobile devices, are often used in multiple contexts. In addition to the new features provided by the telecommunication devices, users of such telecommunication devices have greatly increased. Such an increase in users is only expected to continue and in fact, it is expected that there could be a growth rate of twenty times more users in the next few years alone.

With the increase in mobile devices, applications for execution on mobile devices have also greatly increased. Such applications can be stand-alone applications or can be applications that provide access to networks such as, for example, the Internet, and sites or websites located thereon. However, it can be difficult to test such applications, especially with respect to testing various user interfaces within the applications. Likewise, it can be difficult to efficiently and easily provide a “how to” guide for users of various applications.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates a flow diagram that illustrates user interface paths between various views or pages produced by content, in accordance with various embodiments.

FIG. 2 is a flowchart illustrating an example of a computer-implemented method of mapping user interfaces within content to create the flow diagram of FIG. 1, in accordance with various embodiments.

FIG. 3 illustrates a component level view of an example mobile device configured for use in a wireless communication network, where the mobile device includes a mapping application that can create the flow diagram of FIG. 1 that illustrates user interface paths between various views or pages produced by content.

FIG. 4 illustrates a component level view of a server, where server includes a mapping application that can create the flow diagram of FIG. 1 that illustrates user interface paths between various views or pages produced by content.

### DETAILED DESCRIPTION

Described herein are techniques for mapping of user interfaces within content such as, for example, applications, programs and network sites such as, for example, websites on the Internet.

In accordance with various embodiments, a mapping application or program evaluates content such as applications, programs, network sites, websites, etc., in order to determine locations of user interfaces (UIs) within the applications, programs, websites, etc. As is known, applications generally refer to programs that are executable on mobile devices and other computing devices that include one or more processors for executing computer-readable instructions. Mobile devices are generally capable of accessing a wireless communication network wirelessly in order to perform various functions such as, for example, making phone calls, sending messages, accessing the Internet, etc. The mobile devices may comprise any appropriate devices for communicating over the wireless communication network. Examples of mobile devices include, but are not limited to, mobile telephones, cellular telephones, mobile computers, Personal Digital Assistants (PDAs), radio frequency devices, handheld computers, laptop computers, tablet computers, palmtops and certain devices configured as IoT devices. Other computing devices include, but are not limited to, desktop computers and certain devices configured as IoT devices. Mobile devices and other computing devices may include integrated devices combining one or more of the preceding devices, and/or the like. For clarity, the term “content” is utilized herein to encompass applications, other computer-executable programs for execution by devices that include one or more processors, sites located on various networks, websites located on the Internet, and the like.

Generally, Internet of Things refers to a network of physical objects—devices, vehicles, buildings and other items embedded with electronics, software, sensors, and network connectivity—that enables these objects to collect and exchange data. IoT allows objects to be sensed and controlled remotely across existing network infrastructure, creating opportunities for more direct integration of the physical world into computer-based systems, and resulting in improved efficiency, accuracy and economic benefit. When IoT is augmented with sensors and actuators, the technology becomes an instance of the more general class of cyber-physical systems, which also encompasses technologies such as smart grids, smart homes, intelligent transportation and smart cities. Each thing is uniquely identifiable through its embedded computing system, but is able to interoperate within the existing Internet infrastructure.

Upon determining locations of UIs within the content, the mapping application evaluates the UIs to determine where within the content a UI will lead a user when that UI is activated. For example, the mapping application determines a first location where a first UI will take the user within the content when the UI is activated. At this first location, the mapping application determines a second location where a second UI located at the first location will take the user when the second UI is activated. For example, in order to determine how the user may reach a location within the content that provides a user's account balance to the user, the mapping application may determine that the user selects a UI labelled “Account” at a first location, which then takes the user to a location with details concerning the user's account. At this location, the mapping application may determine that a second UI labelled as “Account Balance” takes the user to a location within the content that provides the user's account balance to the user.

In accordance with various embodiments, once the mapping application has determined locations of UIs within content and where the UIs take a user upon selection of the UIs, the mapping application generates a flow diagram that illustrates the various UI paths within the content to illustrate how selecting various UIs will “move” a user within the content. In embodiments, the flow diagram may be a document comprising one or more pages. In other embodiments, the flow diagram may be a video that illustrates the various flow paths and “how to” navigate the content to a user. Thus, the flow diagram can be a “site map” when the content is a site within a network, such as, for example, a website within the Internet.

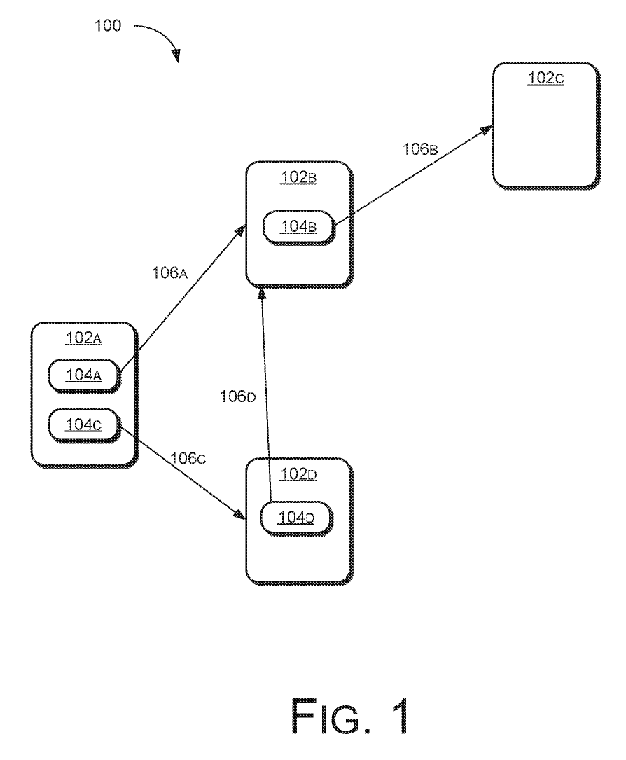

FIG. 1 illustrates a flow diagram that illustrates user interface paths between various views or pages produced by content. More particularly, FIG. 1 illustrates a flow diagram 100 that illustrates various views or pages 102 produced by content. For example, the content may be a website on the Internet and the various pages may represent pages within the website. As can be seen, the various pages include UIs 104. As is known, the UIs 104 may comprise links or “buttons” based upon hypertext mark-up language (HTML) protocols or standards that when selected or activated by a user, transition or move the user within the website among the various pages (or even to a different website). Other examples of UIs 104 include, but are not limited to, text views, radio selectors, check boxes, augmented or virtual interfaces, and other generally explorable items. Thus, as indicated by a first arrow 106a, selecting or activating (interacting with) a first UI 104a on a first page 102a results in transitioning the user from the first page 102a to a second page 102b. As indicated by a second arrow 106b, selecting or activating a second UI 104b on the second page 102b results in transitioning the user to a third page 102c. As indicated by a third arrow 106c, selecting or activating a third UI 104c on the first page 102a results in transitioning the user to a fourth page 102d within the website. Thus, the flow diagram 100 illustrates multiple UI paths, represented by the arrows 106, within the website that includes the four pages 102.

In accordance with embodiments, a mapping application evaluates the content, e.g., the website of FIG. 1, in order to determine locations for the four UIs 104. Once the mapping application has determined the locations of the UIs 104, the mapping application determines the UI path 106 that each UI 104 will provide upon selection or activation of the UI 104. In embodiments, the mapping application may comprise a graph traversal algorithm and thus, the mapping application may then generate the flow diagram 100 as illustrated in FIG. 1. The graph traversal algorithm may provide in-order traversal of the four UIs 104. The graph traversal algorithm may also be configurable as to the order in which UIs 104 and UI paths 106 may be viewed. In embodiments, the flow diagram 100 may be a video for display on a mobile device or other device, or may be a document comprising one or more pages for display on a mobile device or other device. The flow diagram 100 may also be printed at a printing device (not illustrated).

In embodiments, the mapping application determines the locations of the UIs 104 and the various paths associated with the UIs 104 and UI paths 106 by searching and evaluating accessibility nodes within the content. In other embodiments, the mapping application decompiles code associated with the content in order to determine the locations of the UIs 104 and the UI paths 106 that selection of corresponding UIs 104 provides. In other embodiments, the mapping application utilizes optical character recognition (OCR) in order to determine the location of the UIs 104 and the UIs paths 106 that selection of the corresponding UIs 104 provides. In embodiments, the mapping application may use one or more of these example processes described in order to determine the location of the UIs and the corresponding UI paths. In embodiments, the mapping application may use one or more other processes similar to the examples previously described, in combination with or without those examples previously described.

In accordance with various embodiments, once the mapping application has determined locations of UIs 104 within the content and the UI paths 106 that selection or activation of the UIs 104 provide, the mapping application generates the flow diagram 100 that illustrates the various UI paths 106 within the content to illustrate how selecting or activating the various UIs 104 will “move” or transition a user within the content. In embodiments, the mapping application, via a graph traversal algorithm, may generate the flow diagram 100 that provides multiple routes, including an “optimal” route, comprising various UIs 104 and UI paths 106. For example, in the example of FIG. 1, a fourth UI 104d on the fourth page 102d may result in transitioning a user to the second page 102b as represented by a UI path 106d. In such an example, an optimal route to the third page 102c may be deemed to include UIs 104a and 104b represented by UI paths 106a and 106b as such a route will transition the user to the third page 102c without first transitioning to the fourth page 102d. Thus, the mapping application may generate the flow diagram 100 such that the flow diagram 100 provides a spanning tree illustrating multiple routes including the various UIs 104 and UI paths 106.

In embodiments, the flow diagram 100 may be a document comprising one or more pages. In other embodiments, the flow diagram 100 may be a video that illustrates the various flow paths 106 and “how to” navigate the content to a user. Thus, the flow diagram 100 can be a “site map” when the content is a site within a network, such as, for example, a website within the Internet.

While the example of FIG. 1 was described with respect to a website including four pages 102 and three UIs 104, the website may include more or fewer pages 102 and/or UIs 104. The website may comprise code in accordance with HTML, protocols or standards. Furthermore, the example of FIG. 1 may relate to a different content that may include more or fewer pages 102 and/or UIs 104. Such content may or may not comprise code in accordance with HTML protocols or standards. The UIs 104 in such content may or may not be in accordance with HTML protocols or standards. Additionally, the mapping application described herein may be included on a mobile device, a computing device or a server. In accordance with various embodiments, the server may be located within a wireless communication network.

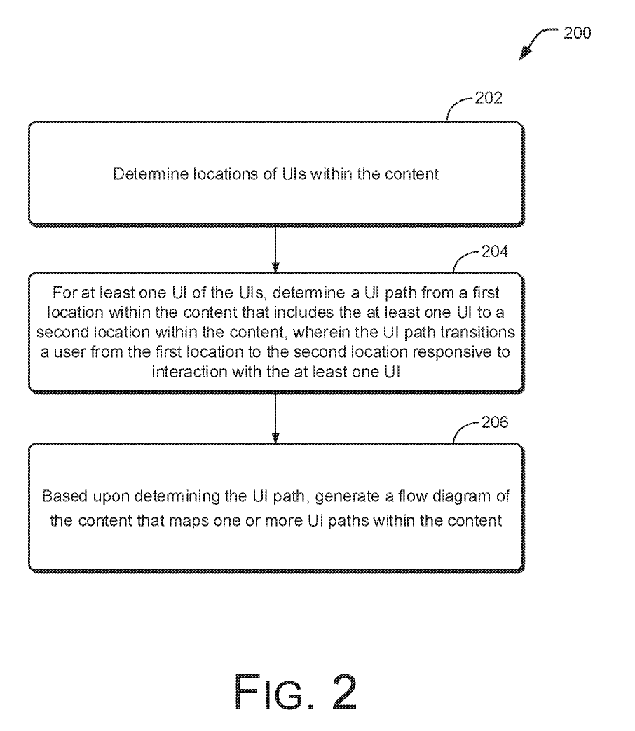

FIG. 2 is a flowchart illustrating an example of a computer-implemented method 200 of mapping user interfaces within content to create a flow diagram, e.g., flow diagram 100. As illustrated, at block 202, locations of UIs within the content are determined. At block 204, for at least one UI of the UIs, a UI path from a first location within the content that includes the at least one UI to a second location within the content is determined, wherein the UI path transitions a user from the first location to the second location responsive to interaction with the at least one UI. At 206, based upon determining the UI path, a flow diagram of the content that maps one or more UI paths within the content is generated.

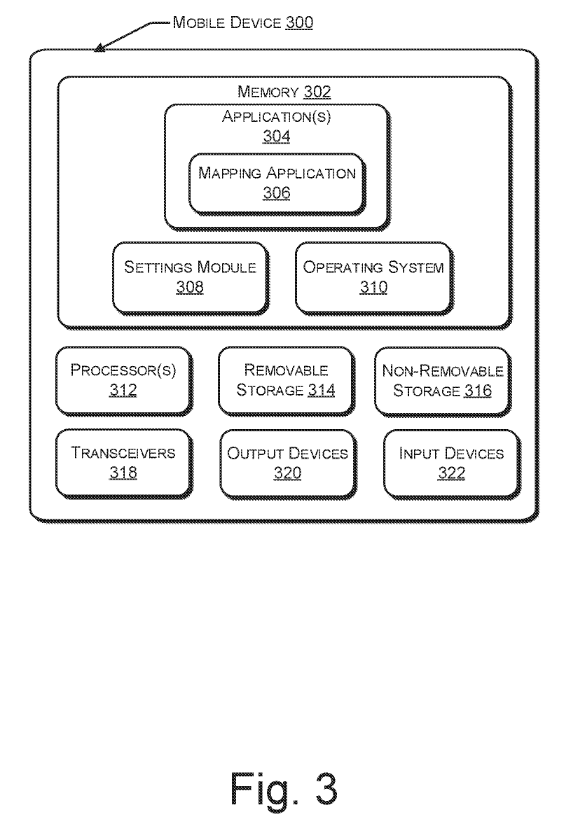

FIG. 3 illustrates a component level view of a mobile device 300 configured to function within a wireless communication network. As illustrated, the mobile device 300 comprises a system memory 302 storing application(s) 304, which includes a mapping application 306, a settings module 308, and an operating system 310. Also, the mobile device 300 includes processor(s) 312, a removable storage 314, a non-removable storage 316, transceivers 318, output device(s) 320, and input device(s) 322. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit. The mapping application 306 is configured to map UIs, e.g., UIs 104, within content to create a flow diagram, e.g., flow diagram 100, as described herein.

The mobile device 300 may also include additional data storage devices (removable and/or non-removable) such as, for example, magnetic disks, optical disks, or tape. Such additional data storage may include removable storage 314 and non-removable storage 316.

Non-transitory computer-readable media may include volatile and nonvolatile, removable and non-removable tangible, physical media implemented in technology for storage of information, such as computer readable instructions, data structures, program modules, or other data. System memory 302, removable storage 314 and non-removable storage 316 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the user device 300. Any such non-transitory computer-readable media may be part of the user device 300.

In some implementations, the transceivers 318 include any sort of transceivers known in the art. For example, the transceivers 318 may include a radio transceiver that performs the function of transmitting and receiving radio frequency communications via an antenna. Also or instead, the transceivers 318 may include wireless modem(s) to may facilitate wireless connectivity with other computing devices. Further, the transceivers 318 may include wired communication components, such as an Ethernet port, for communicating with other networked devices.

In some implementations, the output devices 320 include any sort of output devices known in the art, such as a display (e.g., a liquid crystal display), speakers, a vibrating mechanism, or a tactile feedback mechanism. Output devices 320 also include ports for one or more peripheral devices, such as headphones, peripheral speakers, or a peripheral display.

In various implementations, input devices 322 include any sort of input devices known in the art. For example, input devices 322 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

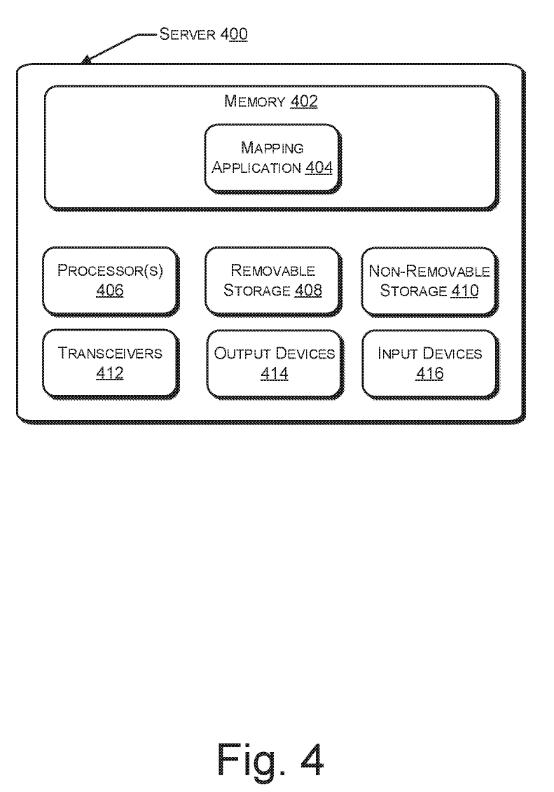

FIG. 4 illustrates a component level view of a server 400 configured for use within a wireless communication network in order to provide various services within the wireless communication network. The server 400 may be located in a radio network controller or gateway. Additionally, the server 400 may be a separate entity located separately from the RNC or gateway. As illustrated, the server 400 comprises a system memory 402 storing a mapping application 404. The system memory 402 may also store additional applications and programs. The mapping application 404 is configured to map UIs, e.g., UIs 104, within content to create a flow diagram, e.g., flow diagram 100, as described herein. Also, the server 400 includes processor(s) 406, a removable storage 408, a non-removable storage 410, transceivers 412, output device(s) 414, and input device(s) 416.

In various implementations, system memory 402 is volatile (such as RAM), non-volatile (such as ROM, flash memory, etc.) or some combination of the two. In some implementations, the processor(s) 406 is a central processing unit (CPU), a graphics processing unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 408 and non-removable storage 410.

Non-transitory computer-readable media may include volatile and nonvolatile, removable and non-removable tangible, physical media implemented in technology for storage of information, such as computer readable instructions, data structures, program modules, or other data. System memory 402, removable storage 408 and non-removable storage 410 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 412 include any sort of transceivers known in the art. For example, the transceivers 412 may include wired communication components, such as an Ethernet port, for communicating with other networked devices. Also or instead, the transceivers 412 may include wireless modem(s) to may facilitate wireless connectivity with other computing devices. Further, the transceivers 412 may include a radio transceiver that performs the function of transmitting and receiving radio frequency communications via an antenna.

In some implementations, the output devices 414 include any sort of output devices known in the art, such as a display (e.g., a liquid crystal display), speakers, a vibrating mechanism, or a tactile feedback mechanism. Output devices 414 also include ports for one or more peripheral devices, such as headphones, peripheral speakers, or a peripheral display.

In various implementations, input devices 416 include any sort of input devices known in the art. For example, input devices 416 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A computer-implemented method of mapping user interfaces (UIs) within content, the method comprising:
determining locations of UIs within the content;
for a first UI of the UIs, determining a first UI path from a first location within the content that includes the first UI to a second location within the content, wherein the first UI path transitions a user from the first location to the second location responsive to interaction with the first UI;
for a second UI of the UIs, determining a second UI path from the second location within the content that includes the second UI to a third location within the content, wherein the second UI path transitions the user from the second location to the third location responsive to interaction with the second UI;
for a third UI of the UIs, determining a third UI path from the first location within the content that includes the first UI to a fourth location within the content, wherein the first UI path transitions the user from the first location to the fourth location responsive to interaction with the first UI; and
based upon determining the first, second and third UI paths, generating a flow diagram of the content that maps at least the first, second and third UI paths within the content.

2. A computer-implemented method of mapping user interfaces (UIs) within content, the method comprising:
determining locations of UIs within the content;
for at least one UI of the UIs, determining a UI path from a first location within the content that includes the at least one UI to a second location within the content, wherein the UI path transitions a user from the first location to the second location responsive to interaction with the at least one UI; and
based upon determining the UI path, generating a flow diagram of the content that maps one or more UI paths within the content.

3. The computer-implemented method of claim 2, wherein determining locations of UIs within the content and determining the results for the UIs comprises evaluating accessibility nodes within the content.

4. The computer-implemented method of claim 2, wherein determining locations of UIs within the content and determining the results for the UIs comprises decompiling source code of the content.

5. The computer-implemented method of claim 2, wherein determining locations of UIs within the content and determining the results for the UIs comprises evaluating the content using optical character recognition.

6. The computer-implemented method of claim 2, wherein generating the flow diagram of the content that maps one or more UI paths within the content comprises generating a video illustrating one or more UI paths within the content.

7. The computer-implemented method of claim 2, wherein generating the flow diagram of the content that maps one or more UI paths within the content comprises generating a document illustrating one or more UI paths within the content.

8. The computer-implemented method of claim 2, wherein the content comprises code in accordance with hyper-text mark-up language (HTML) protocol relating to one or more pages of a site accessible via a network.

9. The computer-implemented method of claim 2, wherein the content comprises code relating to a computer executable application.

10. The computer-implemented method of claim 9, wherein at least one of the UIs within the application comprises a UI in accordance with hyper-text mark-up language (HTML) protocol.

11. An apparatus comprising:
a non-transitory storage medium; and
instructions stored in the non-transitory storage medium, the instructions being executable by the apparatus to:
determine locations of UIs within the content;
for at least one UI of the UIs, determine a UI path from a first location within the content that includes the at least one UI to a second location within the content, wherein the UI path transitions a user from the first location to the second location responsive to interaction with the at least one UI; and
based upon determining the UI path, generate a flow diagram of the content that maps one or more UI paths within the content.

12. The apparatus of claim 11, wherein the locations of UIs within the content and the results for the UIs are determined by evaluating accessibility nodes within the content.

13. The apparatus of claim 11, wherein the locations of UIs within the content and the results for the UIs are determined by decompiling source code of the content.

14. The apparatus of claim 11, wherein the locations of UIs within the content and the results for the UIs are determined by evaluating the content using optical character recognition.

15. The apparatus of claim 11, wherein the flow diagram of the content that maps one or more UI paths within the content is generated by generating a video illustrating one or more UI paths within the content.

16. The apparatus of claim 11, wherein the flow diagram of the content that maps one or more UI paths within the content is generated by generating a document illustrating one or more UI paths within the content.

17. The apparatus of claim 11, wherein the content comprises code in accordance with hyper-text mark-up language (HTML) relating to one or more pages of a site accessible via a network.

18. The apparatus claim 11, wherein the content comprises code relating to a computer executable application.

19. The apparatus of claim 18, wherein at least one of the UIs within the application comprises a UI in accordance with hyper-text mark-up language (HTML) protocol.

20. The apparatus of claim 11, wherein the apparatus is included within a mobile device.

21. The apparatus of claim 11, wherein the apparatus is included within a server.
